(19) United States
(12) Patent Application Publication
(10) Pub. No.: US 2026/0330126 A1
(43) Pub. Date: Oct. 22, 2026

(54) EFFICIENT DOCUMENT EDIT CONFLICT RESOLUTION IN COLLABORATIVE WORKSPACES

(71) Applicant: FIGMA, INC., San Francisco, CA (US)

(72) Inventors: Bridger James MAXWELL, Brooklyn, NY (US); Andrew Martin SCHAMP, Oakland, CA (US); Alexander Simon KERN, San Mateo, CA (US)

(21) Appl. No.: 19/183,661

(22) Filed: Apr. 18, 2025

(51) Int. Cl. G06F 40/166; G06F 40/197

(52) U.S. Cl. CPC G06F 40/166; G06F 40/197

(57) ABSTRACT

Embodiments of the present disclosure provide techniques for resolving conflicts between edits to a document generated by client devices participating in a collaborative workspace. An example method includes receiving, from a user of a first computing system, a first set of edits to a document in a collaborative workspace. A second set of edits conflicting in time domain with the first set of edits are received from a second computing system. The first computing system updates the document based a ground-truth representation of the document and on resolving conflicts between the first set of edits and the second set of edits. Generally, the ground-truth representation of the document may be a representation of the document for which conflicts between edits generated on computing systems participating in the collaborative workspace have been resolved. The updated document is displayed on the first computing system.

### BACKGROUND

### Field of the Various Embodiments

Embodiments of the present disclosure relate generally to collaborative workspaces in a computing system and, more specifically, to techniques for efficient document edit conflict resolution in collaborative workspaces.

### Description of the Related Art

Graphic design tools generally allow for the creation of visual assets in a design environment. These visual assets may be defined, for example, as vector assets defined in terms of mathematical relationships between different components or raster assets defined in terms of absolute pixel locations. In some cases, a visual asset may include one or more containers, defined in the vector space, in which raster assets (e.g., images) can be inserted. A visual asset may include any number of visual components, and a visual asset may be defined in terms of relative positioning or other spatial relationships between visual components in the visual asset.

Some graphic design tools may provide a collaborative workspace in which multiple users modify visual assets rendered on a canvas in a design environment hosted by the graphic design tool or code assets associated with these visual assets. In a collaborative workspace, multiple client devices can perform modifications to the canvas simultaneously. When edits are made by a single client device or by client devices operating in different documents (e.g., visual assets in a design environment, where different visual assets are associated with different code assets), conflicts between edits may be easily resolved. However, when conflicting edits are performed in respect of a document, the collaborative workspace may perform conflict resolution between the conflicting edits to determine the order in which the edits are performed to the document and thus the state of the document after the edits have been performed.

Conflict resolution techniques may be computationally expensive, with the expense scaling as the history of modification actions performed in respect of the document increases. For example, conflict resolution techniques that are performed by a coordinating server may allow the server to maintain a conflict-resolved version of the document based on edits generated by client devices and provided to the server for processing. The computational expense of resolving conflicts at a coordinating server generally scales quadratically with the size of a set of changes to be merged into the document (e.g., is performed in O(n²) time). Meanwhile, conflict resolution techniques that are performed by client devices participating in the collaborative workspace may be performed based on a traversal of a data structure containing the edits made to the document by the participating client devices from the beginning of time and also scales at least linearly.

As the foregoing illustrates, what is needed are more effective techniques for conflict resolution in collaborative workspaces.

### SUMMARY

One embodiment of the present disclosure provides techniques for resolving conflicts between edits to a document generated by client devices participating in a collaborative workspace. An example method includes receiving, from a user of a first computing system, a first set of edits to a document in a collaborative workspace. A second set of edits conflicting in time domain with the first set of edits are received from a second computing system. The first computing system updates the document based on a ground-truth representation of the document and on resolving conflicts between the first set of edits and the second set of edits. Generally, the ground-truth representation of the document may be a representation of the document for which conflicts between edits generated on computing systems participating in the collaborative workspace have been resolved. The updated document is displayed on the first computing system.

One embodiment of the present disclosure provides techniques for resolving conflicts between edits to a document generated by client devices participating in a collaborative workspace. An example method includes receiving, at a server hosting a collaborative workspace from a first computing system, a first set of edits to a document in the collaborative workspace. The server also receives, from a second computing system, a second set of edits to the document in the collaborative workspace, the first set of edits and the second set of edits comprising edits conflicting in time domain. The server updates the document based on a ground-truth conflict-resolved representation of the document maintained by the server for computing devices participating in the collaborative workspace and resolving conflicts between the first set of edits and the second set of edits. The server distributes the updated document to one or more computing systems. Generally, the updated document represents a base document usable by the one or more computing systems for performing edits locally and propagating the edits to other computing systems participating in the collaborative workspace.

One technical advantage of the disclosed techniques relative to the prior art is that the disclosed techniques allow for efficient conflict resolution when edits to a document are performed by multiple parties participating in a collaborative workspace. Because edits can be processed locally and on a coordinating server in parallel, the coordinating server may be used to generate a ground-truth document that resolves the conflicts. Subsequently, the coordinating server can provide the ground-truth document to participating client devices when the client devices connect to the coordinating server. These client devices may treat the ground-truth document as a document for which edits need not be locally resolved, and thus, conflict resolution between edits made by participating client devices in the collaborative workspace may be limited to edits made after a timestamp associated with the ground-truth document. Because local conflict resolution may be performed with respect to a limited set of edits performed with respect to a document, embodiments presented herein may reduce the amount of computational resources used in performing conflict resolution between edits made by client devices participating in a collaborative workspace. For example, the amount of processing cycle, memory, and power used by client devices participating in a collaborative workspace may be reduced by using a ground-truth conflict-resolved document as the basis for which future conflict resolution is performed, as edits prior to the timestamp associated with the ground-truth conflict-resolved document need not be resolved locally. Thus, the size of the space over which conflicting edits are resolved may be significantly smaller than the total number of edits performed in respect of a document, and prior edits need not be processed again in order to resolve current conflicts between edits performed by client devices participating in a collaborative workspace.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present disclosure.

FIG. 2 illustrates examples of conflict resolution performed with respect to conflicting edits made by different client devices participating in a collaborative workspace, according to some embodiments.

FIG. 3 is a message flow diagram illustrating messages exchanged between client devices participating in a collaborative workspace and a server for resolving conflicting edits made by different participating client devices, according to some embodiments.

FIG. 4 illustrates example operations for efficient document edit conflict resolution by a client device participating in a collaborative workspace, according to some embodiments.

FIG. 5 illustrates example operations performed by a server hosting a collaborative workspace for generating a ground-truth conflict-resolved document for client devices to use in local conflict resolution, according to some embodiments.

FIG. 6 illustrates a network computing system to implement an interactive graphic application platform, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

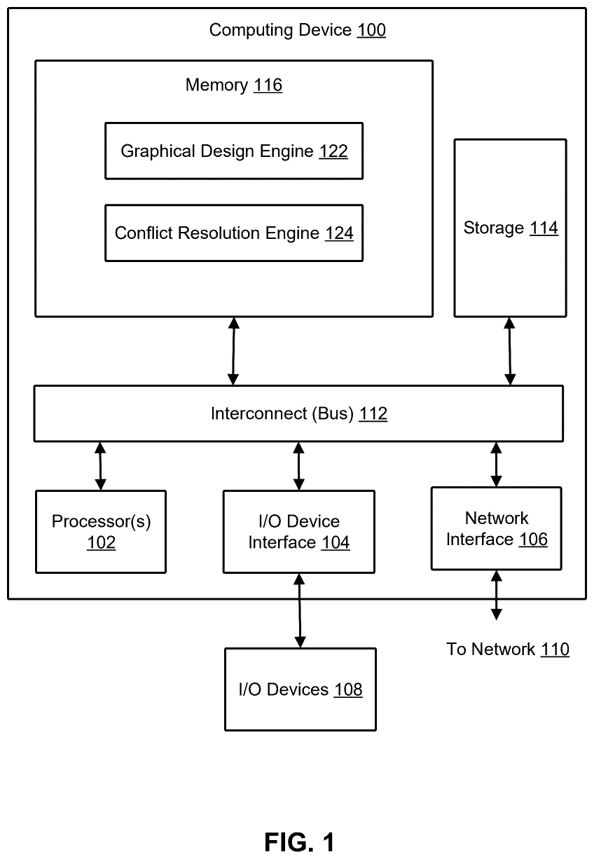

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run graphical design engine 122 and conflict resolution engine 124 that reside in a memory 116.

It is noted that the computing device described herein is illustrative and that any other technically feasible configurations fall within the scope of the present disclosure. For example, multiple instances of graphical design engine 122 and/or conflict resolution engine 124 could execute on a set of nodes in a distributed and/or cloud computing system to implement the functionality of computing device 100. In another example, graphical design engine 122 or conflict resolution engine 124 could execute on various sets of hardware, types of devices, or environments to adapt graphical design engine 122 or conflict resolution engine 124 to different use cases or applications. In a third example, graphical design engine 122 or conflict resolution engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Graphical design engine 122 and/or conflict resolution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including graphical design engine 122 and/or conflict resolution engine 124.

### Example Efficient Conflict Resolution for Document Modifications in a Collaborative Workspace

A collaborative workspace generally allows for multiple client devices to edit a common document. For example, in the context of a design environment (e.g., hosted by a graphical design engine 122), the collaborative workspace generally allows client devices to modify visual assets on a canvas and/or code associated with these visual assets. A collaborative workspace may be managed by the client devices in a peer-to-peer environment or by a central server. When edits are performed by a single client device to a specific document in the collaborative workspace, the edits may be propagated to the other client devices participating in the collaborative workspace without triggering conflict resolution operations that attempt to merge edits to the document that conflict in time domain. However, when conflicting edits to a document exist, conflict resolution techniques are generally used to merge the edits to the document in a way that preserves edits from multiple modification branches (e.g., does not result in, or at least minimizes the likelihood of, edits from one client device resulting in the loss of edits from a different client device).

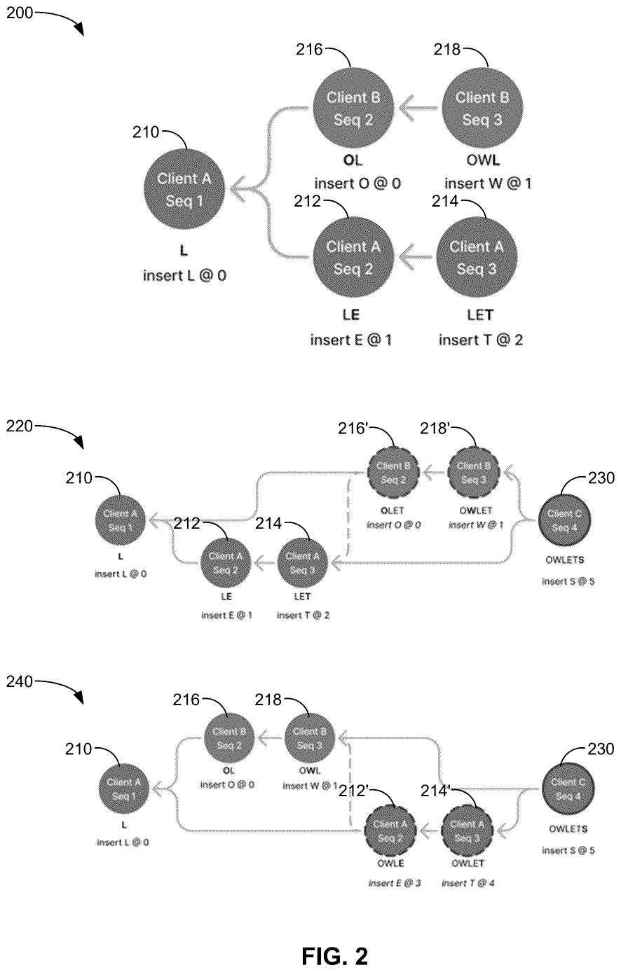

FIG. 2 illustrates examples of conflict resolution performed with respect to conflicting edits made by different client devices participating in a collaborative workspace, according to some embodiments.

Graph 200 illustrates modifications performed with respect to a document by a first client device and a second client device participating in a collaborative workspace. As illustrated, the modifications performed by the first client device and the second client device refer to a common root node 210, in which the character “L” is inserted by the first client device at position 0 in a data structure (e.g., an array representing a string). Nodes 212 and 214 represent subsequent edits to that represented by the root node 210 performed by the first client device. Meanwhile, nodes 216 and 218 represent subsequent edits to that represented by the root node 210 performed by the second client device. That is, nodes 212 and 216 share a common sequence number (e.g., sequence number 2), and nodes 214 and 218 share a different common sequence number (e.g., sequence number 3).

Graph 220 illustrates an example resolution of editing conflicts between the modifications performed by the first client device and the modifications performed by the second client device. As illustrated, nodes 212 and 214 may remain unchanged, with node 210 serving as the parent node to node 212 and node 212 serving as the parent node to node 214. Conflict resolution operations performed on nodes 216 and 218 in graph 200 rebase the modifications in those nodes to result in nodes 216′ and 218′. Node 216′ references node 214 as a parent node in a directed graph representing a sequence of modifications applied to a document, and node 218′ may reference node 216′ as its parent node. A subsequent modification performed by a third client device, represented by node 230, may append another modification to the resolved set of edits represented by nodes 212, 214, 216′, and 218′.

Graph 240 illustrates an example resolution of editing conflicts between the modifications performed by the first client device and the modifications performed by the second client device. In the example illustrated by graph 240, the modifications performed by the second client device, represented by nodes 216 and 218, remain unmodified. Meanwhile, the modifications performed by the first client device, represented by nodes 212′ and 214′, are rebased from the modifications represented by nodes 212 and 214 in graph 200. In generating nodes 212′ and 214′, information about the location at which a modification is performed are modified so that the resulting modifications remain sensical. For example, as illustrated, because the character “L” has moved from index 0 to index 2, the indices of edits coming after the character “L” should also be moved by the same amount. Thus, instead of inserting the character “E” at index 1 (as illustrated by node 212), the character “E” is inserted at index 3 (as illustrated by node 212′). Instead of inserting the character “T” at index 2 (as illustrated by node 214), the character “T” is inserted at index 4 (as illustrated by node 214′). A subsequent modification performed by a third client device, represented by node 230, may append another modification to the resolved set of edits represented by nodes 212, 214, 216′, and 218′. Regardless of whether conflicts are resolved according to graph 220 or graph 240, the resulting content should be the same.

The computational complexity of conflict resolution techniques generally scales with the number of conflicting edits to be resolved and the location at which conflicts between conflicting edits are resolved. For example, in conflict resolution techniques based on resolution at a central server, the computational expense of conflict resolution is O(n²) (e.g., scales quadratically as the number n of edits to be merged increases). In cases in which a large number of edits have not been merged into a document (e.g., due to a client device having performed significant edits to a document while disconnected from the central server), the computational expense of conflict resolution at the central server may be significant.

In conflict resolution techniques based on resolution at client devices participating in the collaborative workspace, the computational expense of conflict resolution may be O(nlogn). In client device-based confliction resolution techniques, each client device maintains a local tree of operations, and conflicts may be resolved when a user of a client device views a portion of a document. Because edits are maintained in a data structure that is processed each time a document (or at least a relevant portion of a document) is rendered, client device-based conflict resolution techniques may use significant amounts of computing resources (e.g., processing cycles, memory, power, etc.) on each client device participating in a collaborative workspace.

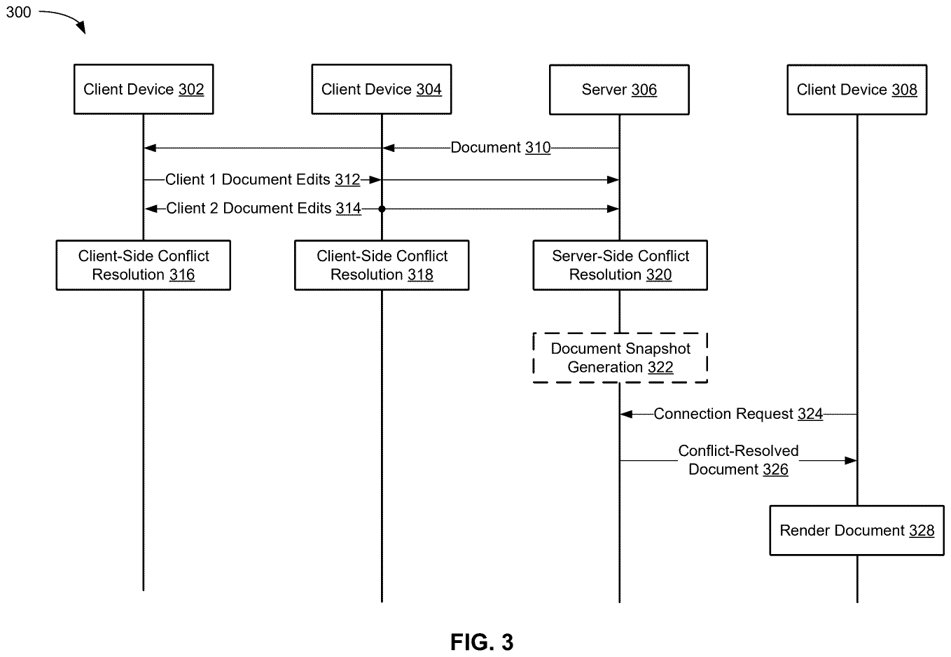

To improve the computational efficiency of conflict resolution, embodiments presented herein use both server-based and client device-based conflict resolution techniques to resolve conflicting modifications performed to a document. FIG. 3 is a message flow diagram 300 illustrating messages exchanged between client devices participating in a collaborative workspace and a server for resolving conflicting edits made by different participating client devices, according to some embodiments. Each of client device 302, 304, and 308, and server 306 executes an instance of graphical design engine 122 and conflict resolution engine 124. Graphical design engine 122 generally hosts a collaborative workspace in which client devices can edit a common document, such as a canvas on which visual assets are rendered and in which code associated with the visual assets is generated. Meanwhile, conflict resolution engine 124 ingests edits made to a document in the collaborative workspace and resolves conflicting edits, as discussed in further detail below. As used herein, a document may be a file or set of files representing content generated and modified collaboratively by multiple client devices participating in a collaborative workspace. A document may include, for example, a text document, a document representing a canvas on which visual assets are rendered and modified, code files associated with visual assets (e.g., code assets defining the appearance and/or functionality of a visual asset) in a graphical design environment, or the like.

Generally, in the collaborative workspace, client devices can obtain a ground-truth conflict-resolved version of a document when these client devices connect with a central server on which the design environment and a collaborative workspace executes. For example, as illustrated in message flow diagram 300, first client device 302 and second client device 304 connect to server 306 prior to users of these client devices generating edits to a document maintained in the collaborative workspace. In response to first client device 302 and second client device 304 connecting to server 306, server 306 transmits a document 310 to the first client device 302 and the second client device 304. Generally, document 310 may be a version of a document for which prior conflicts have been resolved by server 306. Document 310 may be, for example, represented as a conflict-resolved list of modifications made to a document. In such an example, the client devices 302 and 304 can render the document based on traversing the conflict-resolved list of modifications made to the document. In some embodiments, document 310 may be a snapshot of the document. A snapshot of the document may generally represent a ground-truth version of the document that can be rendered without traversal of a modification history for the document.

To allow for efficient conflict resolution at the client devices 302, 304 and to minimize conflict resolution operations performed by other client devices not currently participating in the collaborative workspace, the first client device 302 provides document edits 312 to the second client device 304 (and other peer client devices currently participating in the collaborative workspace, not illustrated in FIG. 3) and the server 306. Meanwhile, the second client device 304 provides document edits 314 to the first client device 302 and server 306. After the conflicting document edits 312 and 314 are distributed across the first client device 302, the second client device 304, and the server 306, conflict resolution blocks 316, 318, 320 are executed substantially in parallel.

At client devices 302 and 304, client-side conflict resolution blocks 316 and 318, respectively, operate to organize the document 310 and the document edits 312 and 314 into a data structure that allows for the conflicts to be resolved. In some embodiments, the data structure may be a tree with the document 310 being represented as a root node of the tree. Edits made to the document 310 may be represented as child nodes of the document 310 in the tree data structure. As discussed above, client-side conflict resolution blocks 316 and 318 can perform conflict resolution on the conflicting edits 312 and 314 by leaving one of edits 312, 314 unmodified and rebasing the other edits. For example, client-side conflict resolution blocks 316, 318 can leave edits 312 unmodified and rebase edits 314 to follow the edits 312; in another example, client-side conflict resolution blocks 316, 318 can leave edits 314 unmodified and rebase edits 312 to follow the edits 314. Regardless of how client-side resolution blocks 316, 318 resolve conflicts between the edits 312 and 314, the end-state of the document (represented by the aggregation of document 310, edits 312, and edits 314) should be consistent across client device 302 and 304.

Edits 312 and edits 314 may be provided to the other clients in the collaborative workspace and to server 306 in a manner that includes both the original edit and locally conflict-resolved edit. By doing so, a receiving device in the collaborative workspace can append a received edit 312, 314 to a local modification history for the document. If a received edit conflicts with a local edit, the client device can resolve a conflict using the original edit information included in the received edit.

Generally, conflict resolution blocks 316 and 318 can operate on historical data up to the point at which a conflict exists. For example, historical data from a time at which a client device 302, 304, 308 may be resolved from a time at which a client device last joined the collaborative workspace (e.g., by connecting to other client devices via peer-to-peer communications and to server 306) and a current amount of time. That is, client devices 302 and 304 can perform conflict resolution on a subset of modifications that is significantly smaller than the total number of modifications that have been performed in respect of a document. Because the client devices 302 and 304 perform conflict resolution on a subset of modifications for the document—for example, conflicting modifications that have been performed between a current time and the last time a client device joined the collaborative workspace—client devices 302 and 304 may more efficiently perform conflict resolution than in client device-based conflict resolution that generates a document based on conflict resolution performed on modification events from the beginning of time.

As discussed, server 306 can perform conflict resolution in parallel at server-side conflict resolution block 320 with the client-side conflict resolution blocks 316, 318 executed on the client devices 302, 304. Execution of the server-side conflict resolution block 320 generally results in server 306 generating a canonical (or ground-truth), conflict-resolved version of a document based on the document 310 and the edits 312, 314 generated by the client devices 302, 304, respectively. In some embodiments, server-side conflict resolution block 320 executes to generate an ordered list of modifications to a document such that traversal of the ordered list results in rendering of the latest version of the document. The ordered list may, for example, be a linked list or a linear array in which index 0 of the list corresponds to a defined state of the document and modifications can be applied to the document based on in-order traversal of the document.

In some embodiments, the defined state of the document, represented by document 310, may be a previously generated snapshot of the document. The snapshot of the document may serve as a root node or index 0 of an ordered list based on which future modifications to a document can be added. In such a case, a design environment provided by graphical design engine 122 can generate a conflict-resolved version of a document without repeating resolution of prior conflicting edits or traversing the entire history of a document in order to generate a conflict-resolved version of a document.

In some embodiments, as illustrated by optional document snapshot generation block 322, server 306 can generate a snapshot of the document based on the document 310 and the edits 312 and 314 for which conflicts have been resolved. The snapshot may replace an ordered list of modifications performed in respect of a document so that client devices participating in the collaborative workspace can apply modifications according to a canonical version of the document.

Subsequently, a client device 308 can join the collaborative workspace via connection request 324. To allow for client device 308 to join the collaborative workspace and operate on the latest version of a document, server 306 responds to the connection request 324 with a conflict-resolved document 326. As discussed, the server 306 may provide the conflict-resolved document 326 to client device 308 as an ordered list of modifications that, when traversed, results in creation of the document or as a snapshot of the document. Subsequently, at block 328, client device 308 renders the document and begins listening for modifications to the document 326. As discussed, when client device 308 receives modifications to the document 326, client device 308 can propagate the modifications to server 306 and other client devices participating in the collaborative workspace for application to the document 326 and conflict resolution.

In some embodiments, server 306 may receive edits to a document when a client device 302, 304, or 308 (amongst others) joins a collaborative workspace. These edits may, for example, be offline edits performed on a document while a client device is disconnected from the collaborative workspace. To allow for these offline edits to be joined to the document and propagated to other client devices participating in the collaborative workspace, server 306 may maintain a modification history to which the offline edits can be merged. After merging the offline edits with the document, server 306 can distribute the updated document including these offline edits to other client devices participating in the collaborative workspace.

In some embodiments, server 306 can monitor the edits generated by client devices 302, 304, 308 (amongst others not illustrated in FIG. 3) to determine whether edits should be applied to a document. Generally, edits that should not be applied to a document may include malicious edits (e.g., edits that introduce malicious code to a document), highly destructive edits (e.g., edits that delete significant portions of a document, replace significant portions of a document with invalid or nonsensical data, etc.), edits that cause the document to lose functionality or fail to render, or other edits that should not be propagated to client devices participating in the collaborative workspace. When such edits are encountered, server 306 can discard such edits so that the document is unmodified. In some embodiments, server 306 can generate a copy of the document including the edits and request feedback on the edited copy of the document from other client devices participating in the collaborative workspace. If a sufficient number of client devices participating in the collaborative workspace approve the modifications in the edited copy of the document, then server 306 can apply the edits to the document and propagate the edited document to the client devices participating in the collaborative workspace.

In some embodiments, a conflict-resolved version of a document may be merged with a new conflicting document. The new conflicting document may be received from a client device that has reconnected to server 306 and may include edits to a document starting from an earlier point in time. To merge these documents, the server 306 can resolve conflicts between the conflict-resolved version of the document (e.g., the current version of the document, after conflicting edits generated by the client devices 302, 304, 308, amongst others not illustrated in FIG. 3, are resolved) and the new conflicting document. Server 308 may subsequently distribute the new conflict-resolved version of the document, and the corresponding conflict resolution history, to client devices 302, 304, 308. By doing so, embodiments presented herein may allow for resolution of edits made to a document throughout the history of the document.

As illustrated in FIG. 3, embodiments of the present disclosure allow for conflict resolution operations to be performed locally on a client device 302, 304, 308 or server 306. Because conflict resolution may be performed on client devices or central servers to which client devices connect, embodiments may leverage the efficiency of server-based conflict resolution and the flexibility of client device-based conflict resolution. For example, client devices that have not connected to the server for a long time may retrieve a conflict-resolved version of the document (or a history of edits) from the server and integrate the conflict-resolved version of the document and local edits on the client device. The client device can, in some embodiments, let a user approve the new resolved document prior to propagating the new resolved document to the server 306 for further propagation. In some embodiments, because conflict resolution operations may be performed independently on client devices and a central server, conflict resolution may be performed on the client devices (e.g., client devices 302 and 304) via direct propagation of edits when the server 306 is unavailable and resume propagating edits to the server when the server 306 becomes accessible again.

In some embodiments, parallel client-side and server-side conflict resolution discussed herein and illustrated in FIG. 3 may allow for flexible conflict resolution that maximizes computational efficiency or resource utilization. For example, if client devices 302 and 304 are located on the same network and are separated from server 306 by a slower network link, client devices 302 and 304 can be configured to perform local conflict resolution without sending the edits to server 306. After conflicting edits are resolved, one or both of client devices 302 or 304 can provide the conflict-resolved document to server 306. In some embodiments, the client devices 302 and 304 can provide edits in batches of edits to server 306 for server-side resolution. It should be recognized, however, various optimizations to client-side and server-side conflict resolution may be defined to maximize, or at least improve, computational efficiency and resource utilization, and the foregoing are illustrative examples of such optimizations.

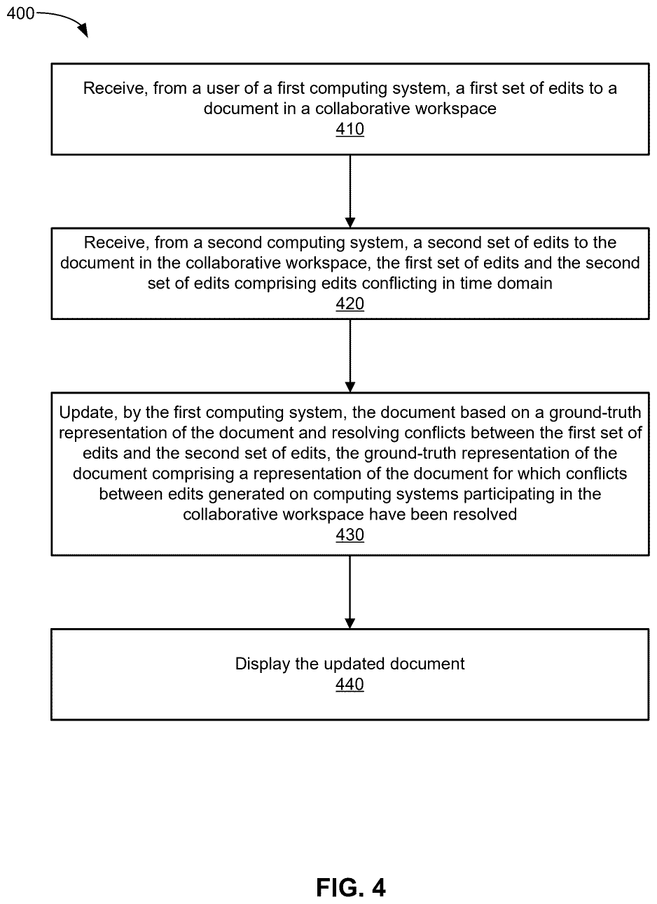

FIG. 4 illustrates example operations 400 for efficient document edit conflict resolution by a client device participating in a collaborative workspace, according to some embodiments. The operations 400 may be performed, for example, by a computing system including one or more processors, such as the processor(s) 102 of the computing device 100 illustrated in FIG. 1 on which a conflict resolution engine (e.g., conflict resolution engine 124 illustrated in FIG. 1) executes to resolve conflicting modifications to a document.

As illustrated, operations 400 begin at block 410, where conflict resolution engine 124 receives a first set of edits to a document in a collaborative workspace from a user of the client device (which may be a first computing system participating in the collaborative workspace).

At block 420, operations 400 proceed with conflict resolution engine 124 receiving, from a second computing system, a second set of edits to the document in the collaborative workspace. Generally, the first set of edits and the second set of edits comprising edits conflict in time domain. Conflicting edits in time domain may be, for example, edits that reference the same document state, such a same node in a graph or other data structure representing operations performed in respect of a document.

At block 430, operations 400 proceed with conflict resolution engine 124 at the first computing system updating the document based on a ground-truth representation of the document and on resolving conflicts between the first set of edits and the second set of edits. Generally, the ground-truth representation of the document may be a representation of the document for which conflicts between edits generated on computing systems participating in the collaborative workspace have been resolved.

In some embodiments, the ground-truth representation of the document comprises an ordered list of sequential edits to the document. An initial item in the ordered list (e.g., the item at index 0) may represent a beginning state of a document, which may represent a blank document or a snapshot representing a state of the document at a prior point in time. To update the document, operations 400 may further include the conflict resolution engine traversing the ordered list (e.g., walking through the list from index 0 to index n) and appending the first set of edits and the second set of edits to the ordered list based on an order in which conflicts are resolved between the first set of edits and the second set of edits.

In some embodiments, the ground-truth representation of the document may be a snapshot of the document. Generally, future edits may be applied to the snapshot of the document. To do so, in some embodiments, the snapshot of the document may become the root node of a tree data structure on which child nodes representing modifications to the document can be added. In some embodiments, the snapshot of the document may be inserted at index 0 of an ordered list, with modifications to the document being inserted as subsequent items in the ordered list. In some embodiments, the ground-truth representation of the document may be received from a server maintaining the collaborative workspace. For example, the ground-truth representation of the document may be received when the first computing device connects or otherwise joins the collaborative workspace. In another example, the ground-truth representation of the document may be received while the first computing device is connected to the collaborative workspace, such as when the server maintaining the collaborative workspace merges edits to a document from a client device on which offline editing has been performed.

In some embodiments, updating the document comprises resolving conflicts for a subset of a universe of edits made to the document by computing systems participating in the collaborative workspace. For a document with m total modifications performed on the document, conflict resolution engine 124 can resolve conflicts between the n conflicting edits performed on the document since the last time at which the document was in a steady state. Thus, conflict resolution may be performed on a client device such as the first computing system of the second computing system more efficiently, as conflict resolution operations may be performed with respect to n <<m modifications to a document.

At block 440, operations 400 proceed with conflict resolution engine 124 displaying the updated document on the first computing system.

In some embodiments, operations 400 may include transmitting, to a server maintaining the collaborative workspace, the first set of edits. Generally, the conflict resolution engine 124 at the first computing system may perform conflict resolution on a local copy of the document substantially in parallel with the server updating the document based on the first set of edits and the second set of edits.

In some embodiments, each respective edit in the first set of edits comprises a tuple of a sequence value associated with the respective edit, a location at which the respective edit was performed in the document, and content of the respective edit. Edits may include, for example, character-level modifications to a document, word-level modifications to a document, or the like.

In some embodiments, the document may be a graphical design rendered in a design environment provided by the collaborative workspace. For example, a document representing a graphical design may include a canvas on which visual assets are rendered and/or documents (e.g., code files) defining the appearance of and/or functionality attached to a visual asset. In some embodiments, the first set of edits and the second set of edits comprise edits to content associated with a visual component of the graphical design. In such an embodiment, conflict resolution engine 124 can perform conflict resolution on the first set of edits and the second set of edits within a portion of the document in which the visual appearance of the visual component is defined or in which functionality associated with the visual component is defined.

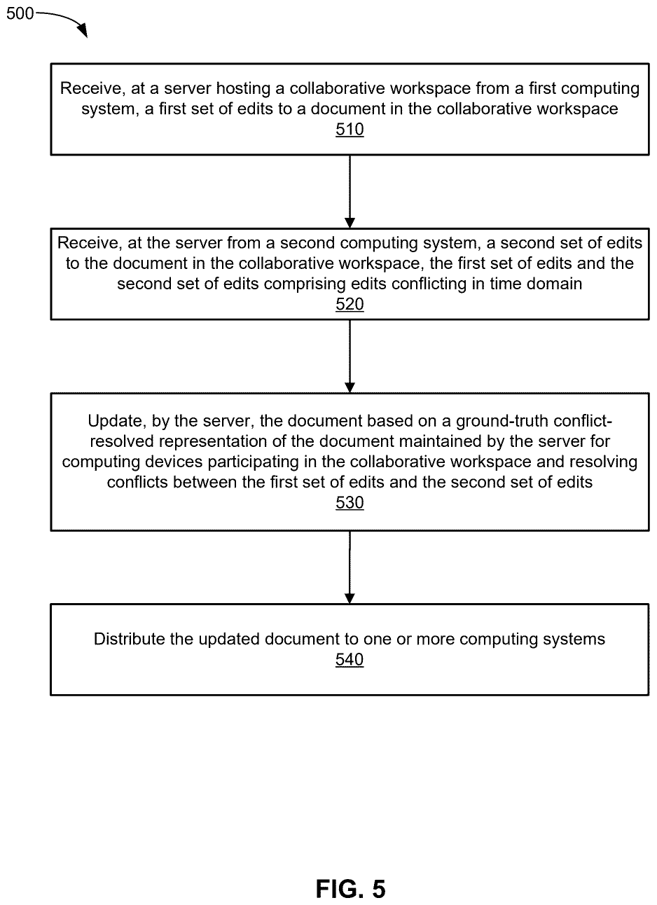

FIG. 5 illustrates example operations 500 performed by a server hosting a collaborative workspace for generating a ground-truth conflict-resolved document for client devices to use in local conflict resolution, according to some embodiments. The operations 400 may be performed, for example, by a computing system including one or more processors, such as the processor(s) 102 of the computing device 100 illustrated in FIG. 1 on which a conflict resolution engine (e.g., conflict resolution engine 124 illustrated in FIG. 1) executes to resolve conflicting modifications to a document.

As illustrated, operations 500 begin at block 510, with conflict resolution engine 124 receiving a first set of edits to a document in the collaborative workspace. Conflict resolution engine 124 may execute on a server hosting a collaborative workspace and may receive the first set of edits to the document from a first computing system participating in the collaborative workspace.

At block 520, operations 500 proceed with conflict resolution engine 124 receiving, from a second computing system, a second set of edits to the document in the collaborative workspace. Generally, the first set of edits and the second set of edits comprising edits may conflict in time domain. As discussed, edits conflicting in time domain may include edits that reference the same document state, such as a same node in a graph or other data structure representing operations performed in respect of a document.

At block 530, operations 500 proceed with conflict resolution engine 124 updating, the document based on a ground-truth conflict-resolved representation of the document maintained by the server for computing devices participating in the collaborative workspace and resolving conflicts between the first set of edits and the second set of edits.

In some embodiments, conflict resolution engine 124 updates the document is performed in parallel with local document updates performed by the first computing system and the second computing system.

In some embodiments, the ground-truth conflict-resolved representation of the document comprises an ordered list of sequential edits to the document. An initial item in the ordered list (e.g., the item at index 0) may represent a beginning state of a document, which may represent a blank document or a snapshot representing a state of the document at a prior point in time. To update the document, conflict resolution engine 124 traverses the ordered list (e.g., walking through the list from index 0 to index n) and appends the first set of edits and the second set of edits to the ordered list based on an order in which conflicts are resolved between the first set of edits and the second set of edits.

In some embodiments, the ground-truth conflict-resolved representation of the document may be a previously generated snapshot of the document. The previously generated snapshot of the document may be, for example, a version of the document captured after prior conflicts between edits generated by client devices participating in the collaborative workspace have been resolved. To update the document, conflict resolution engine 124 resolves conflicts between the first set of edits and the second set of edits and applies the post-resolution first set of edits and second set of edits to the snapshot of the document. To do so, in some embodiments, the snapshot of the document may become the root node of a tree data structure on which child nodes representing modifications to the document can be added. In some embodiments, the snapshot of the document may be inserted at index 0 of an ordered list, with modifications to the document being inserted as subsequent items in the ordered list.

In some embodiments, conflict resolution engine 124 updates the document based on resolving conflicts for a subset of a universe of edits made to the document by computing systems participating in the collaborative workspace. In such a case, conflict resolution may reach back as far as the earliest conflicting edit that has not already been resolved. For a document with m modifications in total, conflict resolution engine 124 can perform conflict resolution operations for n conflicting edits, with n<<m.

At block 540, operations 500 proceed with conflict resolution engine 124 distributing the updated document to one or more computing systems. Generally, the updated document may be a base document usable by the one or more computing systems for performing edits locally and propagating the edits to other computing systems participating in the collaborative workspace.

In some embodiments operations 500 further include conflict resolution engine 124 generating a snapshot of the updated document. Generally, distributing the updated document to the one or more computing systems may include distributing the generated snapshot.

In some embodiments, operations 500 further include conflict resolution engine 124 determining that the first set of edits to the document are invalid edits to the document. Conflict resolution engine 124 can discard the first set of edits based on the determination such that the document is updated based on the second set of edits but not the first set of edits. In some embodiments, conflict resolution engine 124 determines that the first set of edits are invalid edits to the document based on that the first computing system is a malicious computing system.

In some embodiments, the document may be a graphical design rendered in a design environment provided by the collaborative workspace. For example, a document representing a graphical design may include a canvas on which visual assets are rendered and/or documents (e.g., code files) defining the appearance of and/or functionality attached to a visual asset. In some embodiments, the first set of edits and the second set of edits comprise edits to content associated with a visual component of the graphical design. In such an embodiment, conflict resolution engine 124 can perform conflict resolution on the first set of edits and the second set of edits within a portion of the document in which the visual appearance of the visual component is defined or in which functionality associated with the visual component is defined.

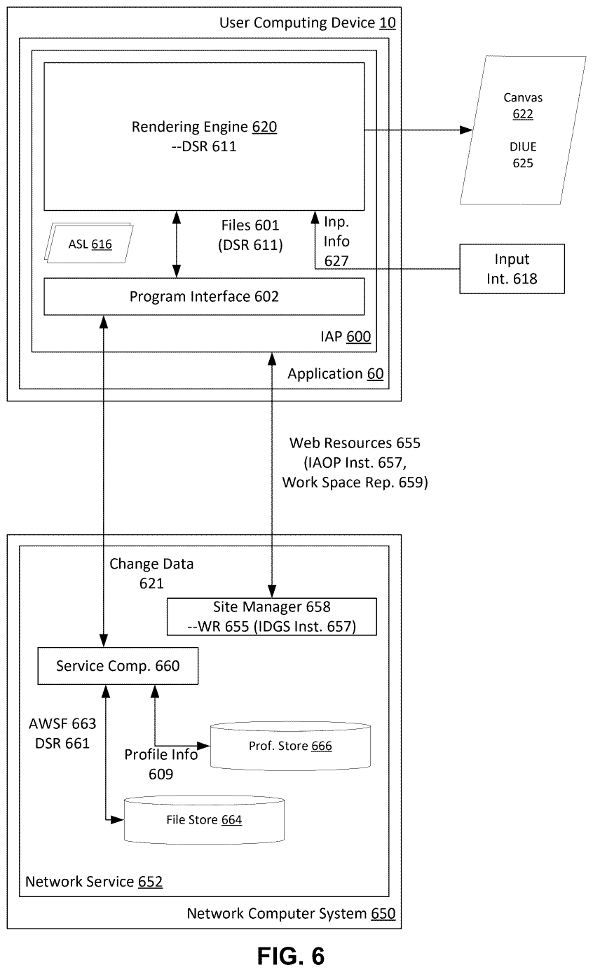

FIG. 6 illustrates a network computing system to implement an interactive application platform on a user computing device, according to some embodiments. A network computing system such as illustrated in FIG. 6 can be implemented using one or more servers which communicate with user computing devices over one or more networks. The network computer system 650 illustrated in FIG. 6 may correspond, for example, to the computing device 100 illustrated in FIG. 1 and can be used to resolve conflicts between edits to a document generated by client devices participating in a collaborative workspace.

In some embodiments, the network computing system 650 performs operations to enable an interactive application platform (“IAP 600”) to be implemented on user computing devices 10. In some embodiments, the IAP 600 can be implemented by the user initiating a session (e.g., user accessing a website) to receive programmatic resources of the IAP 600. A browser component executes the programmatic resources to implement the IAP 600, with functionality to receive user input and to render content that is based on or responsive to user input. As described, the IAP 600 is implemented to enable the user to create various types of content, such as interactive graphic designs, art, whiteboard content, program code renderings, presentations, and/or textual content. As further described, the IAP 600 can include logic (“ASL 616”) for implementing one or more application services, where each application service is implemented through the IAP 600 to provide a corresponding set of functionality and user experience. The IAP 600 also implements the application services to share some resources, such as the canvas, workspace file or library of design elements. Further, the IAP 600 enables multiple application services to be used during a given online session and/or with respect to a particular application service.

According to some embodiments, a user of computing device 10 operates web-based application 80 to access a network site, where programmatic resources are retrieved and executed to implement the IAP 600. The web-based application 80 can execute scripts, code and/or other logic (the “programmatic components”) to implement functionality of the IAP 600. In some embodiments, the web-based application 80 can correspond to a commercially available browser, such as GOOGLE CHROME (developed by GOOGLE, INC.) or SAFARI (developed by APPLE, INC.). In some embodiments, the processes of the IAP 600 can be implemented as scripts and/or other embedded code which web-based application 80 downloads from a network site. For example, the web-based application 80 can execute code that is embedded within a webpage to implement processes of the IAP 600. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some embodiments, the rendering engine 620 may utilize graphics processing unit (GPU) accelerated logic, such as provided through WebGL (Web Graphics Library) programs which execute Graphics Library Shader Language (GLSL) programs that execute on GPUs.

The IAP 600 can be implemented as part of a network service, where web-based application 80 communicates with one or more remote computers (e.g., server used for a network service) to execute processes of the IAP 600. The web-based application 80 retrieves some or all of the programmatic resources for implementing the IAP 600 from a network site. The web-based application 80 may also access various types of data sets in providing the IAP 600. The data sets can correspond to files and design libraries (e.g., predesigned design elements), which can be stored remotely (e.g., on a server, in association with an account) or locally. In some embodiments, the network computer system 650 provides a shared design library which the user computing device 10 can use with any of the application services provided through the IAP 600. In this way, the user may initiate a session to implement the IAP 600 for the purpose of creating or editing the workspace file, as rendered on the canvas 622, in accordance with one of multiple collaborative application services of the IAP 600.

In some embodiments, the IAP 600 includes a program interface 602, an input interface 618 and a rendering engine 620. The program interface 602 can include one or more processes which execute to access and retrieve programmatic resources from local and/or remote sources. In an implementation, the program interface 602 can generate, for example, a canvas 622, using programmatic resources which are associated with web-based application 80 (e.g., HTML 5.0 canvas). As an addition or variation, the program interface 602 can trigger or otherwise cause the canvas 622 to be generated using programmatic resources and data sets (e.g., canvas parameters) which are retrieved from local (e.g., memory) or remote sources (e.g., from network service).

The program interface 602 may also retrieve programmatic resources that include an application framework for use with canvas 622. The application framework can include data sets which define or configure, for example, a set of interactive graphic tools that integrate with the canvas 622 and which comprise the input interface 618, to enable the user to provide input to generate or update content rendered on the canvas 622.

According to some embodiments, the input interface 618 can be implemented as a functional layer that is integrated with the canvas 622 to detect and interpret user input. The input interface 618 can, for example, process a user's interaction with an input mechanism (e.g., pointer device, keyboard) of the user computing device, to detect, for example, cursor positioning/movement with respect to the canvas 622, hover input (e.g., pre-selection input), selection input (e.g., clicks or double clicks), shortcuts (e.g., key board inputs) and other inputs. In processing a user's interaction with a pointer device, the input interface 618 can use a reference of the canvas 622 to identify a screen location of a user's cursor as the user moves or otherwise interacts with the pointer device. Additionally, the input interface 618 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In some embodiments, the input interface 618 can interpret, for example, a series of inputs as a design tool selection (e.g., shape selection based on location of input), as well as inputs to define attributes (e.g., dimensions) of a selected shape. In some embodiments, the input interface 618 can interpret a continuous input (corresponding to a continuous movement of the user's pointer device) as selecting a tool (e.g., shape too) and canvas location where an output of the selected tool is to appear.

In some embodiments, the IAP 600 includes application service logic 616 to enable multiple application services to be utilized during a given user session, where each application service provides the user with a particular functionality and/or user experience. As described by some embodiments, each application service is implemented by the IAP 600 utilizing a corresponding application service logic 616 to configure the interface component 618, rendering engine 620 and/or other components of the IAP 600 to provide the functionality and user experience of the corresponding application service. In this way, the IAP 600 enables the user to operate multiple application services during one online session. Further, the different application services can share resources, including programmatic resources of the IAP 600, such as canvas 622. In this way, each application service can contribute content to and/or utilize features and content provided with the canvas 622 during a given session. Still further, the application services can be implemented as alternative modalities of IAP 600, such that the user can toggle between modes, where each mode provides a particular functionality and user experience. In some embodiments, each application service can utilize a common workspace file associated with the user. By default, a computing device that opens the workspace file can utilize a default application service to access and/or update that workspace file. The user may also switch the mode of operation of the IAP 600 to utilize a different application service to access, use and/or update the workspace file.

The network computing system 650 can include a site manager 658 to manage a website where a set of web-resources 655 (e.g., web page) are made available for the web-based application 80 of user computing devices 10. The web-resources 655 can include instructions, such as scripts or other logic (“ICAP instructions 657”), which are executable by browsers or web components of user computing devices. The web resources 655 can also include (i) resources that are to be shared as between application services, provided to the user computing devices in connection with the user computing devices utilizing either of the application services, and (ii) application specific resources, which execute on the user computing devices for a particular one of the available application services. The web resources 655 can also include a design library of design elements that is partially or fully shared as between the application services. The library of design elements can enable the user to select predetermined design elements for use on the canvas 622 in connection with the user utilizing either of the application services.

In some variations, once the computing device 10 accesses and downloads the web-resources 655, web-based application 80 executes the IAP instructions 657 to implement functionality as described above. For example, the IAP instructions 657 can be executed by web-based application 80 to initiate the program interface 602 on the user computing device 10. The initiation of the program interface 602 may coincide with the establishment of, for example, a web-socket connection between the program interface 602 and a service component 660 of the network computing system 650.

In some embodiments, the web-resources 655 includes logic which web-based application 80 executes to initiate one or more processes of a program interface 602, causing the IAP 600 to retrieve additional programmatic resources and data sets for implementing functionality as described by examples. The web resources 655 can, for example, embed logic (e.g., JAVASCRIPT code), including GPU accelerated logic, in an HTML page for download by computing devices of users. The program interface 602 can be triggered to retrieve additional programmatic resources and data sets from, for example, the network service 652, and/or from local resources of the computing device 10, in order to implement each of the multiple application services of the IAP 600. For example, some of the components of the IAP 600 can be implemented through webpages that can be downloaded onto the computing device 10 after authentication is performed, and/or once the user performs additional actions (e.g., download one or more pages of the workspace associated with the account identifier). Accordingly, in examples as described, the network computing system 650 can communicate the IAP instructions 657 to the computing device 10 through a combination of network communications, including through downloading activity of web-based application 80, where the IAP instructions 657 are received and executed by web-based application 80.

The computing device 10 can use web-based application 80 to access a website of the network service 652 to download the webpage or web resource. Upon accessing the website, web-based application 80 can automatically (e.g., through saved credentials) or through manual input, communicate an account identifier to the service component 660. In some embodiments, web-based application 80 can also communicate one or more additional identifiers that correlate to a user identifier.

Additionally, in some embodiments, the service component 660 can use the user or account identifier of the user identifier to retrieve profile information 609 from a user profile store 666. As an addition or variation, profile information 609 for the user can be determined and stored locally on the user's computing device 10.

The service component 660 can also retrieve the files of an active workspace (“active workspace files 663”) that are linked to the user account or identifier from a file store 664. The profile store 666 can also identify the workspace that is identified with the account and/or user, and the file store 664 can store the data sets that comprise the workspace. The data sets stored with the file store 664 can include, for example, the pages of a workspace and one or more data structure representations 661 for the design under edit which is renderable from the respective active workspace files.

As an addition or variation, each file can be associated with metadata that identifies the application service that was used to create the particular file. In some embodiments, the metadata identifies the default application service for viewing, utilizing or otherwise updating the application service.

Additionally, in some embodiments, the service component 660 provides a representation 659 of the workspace associated with the user to the web-based application 80, where the representation identifies, for example, individual files associated with the user and/or user account. The workspace representation 659 can also identify a set of files, where each file includes one or multiple pages, and each page including objects that are part of a design interface.

On the user device 10, the user can view the workspace representation through web-based application 80, and the user can elect to open a file of the workspace through web-based application 80. In some embodiments, upon the user electing to open one of the active workspace files 663, web-based application 80 initiates the canvas 622. For example, the IAP 40 can initiate an HTML 5.0 canvas as a component of web-based application 80, and the rendering engine 120 can access one or more data structures representations 611 of content rendered on the canvas 622.

The IAP 600 utilizes application service logic 616 to implement multiple modes of operation, where each mode corresponds to an application service. As described, the application service logic 616 associated with each service application can include instructions and data for configuring the components of IAP 600 to include functionality and features of the corresponding application service. Accordingly, the application service logic 616 can, for example, configure the application framework and/or input interface 618 to differ in form, functionality and/or configuration as between the alternative modes of the IAP 600. Additionally, the type of actions and interactions which the user can perform to register input can vary based on the modes of operation. Still further, the different modes of operation can include different input or user-interface features for the user to select and use for inclusion on the canvas 622. By way of example, when the IAP 600 is operating in a mode for whiteboarding service application, the program interface 602 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 622.

Additionally, the application service logic 616 can configure the operation of the rendering engine 620, such that the functionality and behavior of the rendering engine 620 differs as between different application services. In this way, the rendering engine 620 functions to provide alternative behaviors for different modes of operation, coinciding with the particular service application that is active. By way of example, the configuration of the rendering engine 620 can affect the appearance of the canvas 622, the appearance (e.g., visual attributes) of rendered content elements on the canvas 622, the behavior or representation of user interaction (e.g., whether the user cursor or pointer device is represented on the canvas 622), the type or specific content that is rendered, the physic engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In some embodiments, each application service enables the user to update the workspace file even while the workspace file is in use by other computing devices (e.g., such as in a collaborative environment). In some embodiments, the user can mode switch the IAP 600 to switch which application service is in use, with each application service utilizing the workspace file.

### Example Clauses

Various aspects of the present disclosure are described in the following numbered clauses.
1. In some embodiments, a processor-implemented method, comprising: receiving, from a user of a first computing system, a first set of edits to a document in a collaborative workspace; receiving, from a second computing system, a second set of edits to the document in the collaborative workspace, the first set of edits and the second set of edits comprising edits conflicting in time domain; updating, by the first computing system, the document based a ground-truth representation of the document and on resolving conflicts between the first set of edits and the second set of edits, the ground-truth representation of the document comprising a representation of the document for which conflicts between edits generated on computing systems participating in the collaborative workspace have been resolved; and displaying the updated document on the first computing system.
2. The method of clause 1, wherein: the ground-truth representation of the document comprises an ordered list of sequential edits to the document; and updating the document comprises traversing the ordered list and appending the first set of edits and the second set of edits to the ordered list based on an order in which conflicts are resolved between the first set of edits and the second set of edits.
3. The method of any of clauses 1 or 2, wherein the ground-truth representation of the document comprises a snapshot of the document based on which future edits are applied.
4. The method of any of clauses 1 through 3, further comprising receiving the ground-truth representation of the document from a server maintaining the collaborative workspace based on connecting the first computing system to the collaborative workspace.
5. The method of any of clauses 1 through 4, further comprising transmitting, to a server maintaining the collaborative workspace, the first set of edits.
6. The method of clause 5, wherein the updating the document by the first computing system is performed in parallel with the server updating the document based on the first set of edits and the second set of edits.
7. The method of any of clauses 1 through 6, wherein each respective edit in the first set of edits comprises a tuple of a sequence value associated with the respective edit, a location at which the respective edit was performed in the document, and content of the respective edit.
8. The method of any of clauses 1 through 7, wherein updating the document comprises resolving conflicts for a subset of a universe of edits made to the document by computing systems participating in the collaborative workspace.
9. The method of any of clauses 1 through 8, wherein the document comprises a graphical design rendered in a design environment provided by the collaborative workspace.
10. The method of clause 9, wherein the first set of edits and the second set of edits comprise edits to content associated with a visual component of the graphical design.
11. In some embodiments, a processor-implemented method, comprising: receiving, at a server hosting a collaborative workspace from a first computing system, a first set of edits to a document in the collaborative workspace; receiving, at the server from a second computing system, a second set of edits to the document in the collaborative workspace, the first set of edits and the second set of edits comprising edits conflicting in time domain; updating, by the server, the document based on a ground-truth conflict-resolved representation of the document maintained by the server for computing devices participating in the collaborative workspace and resolving conflicts between the first set of edits and the second set of edits; and distributing the updated document to one or more computing systems, the updated document comprising a base document usable by the one or more computing systems for performing edits locally and propagating the edits to other computing systems participating in the collaborative workspace.
12. The method of clause 11, wherein updating the document is performed in parallel with local document updates performed by the first computing system and the second computing system.
13. The method of any of clauses 11 or 12, wherein the ground-truth conflict-resolved representation of the document comprises an ordered list of sequential edits to the document.
14. The method of any of clauses 11 through 13, further comprising generating a snapshot of the updated document, wherein distributing the updated document to the one or more computing systems comprises distributing the generated snapshot.
15. The method of any of clauses 11 through 14, wherein updating the document comprises resolving conflicts for a subset of a universe of edits made to the document by computing systems participating in the collaborative workspace.
16. The method of any of clauses 11 through 15, further comprising: determining that the first set of edits to the document are invalid edits to the document; and discarding the first set of edits such that the document is updated based on the second set of edits but not the first set of edits.
17. The method of clause 16, wherein determining that the first set of edits are invalid edits to the document comprises determining that the first computing system is a malicious computing system.
18. The method of any of clauses 11 through 17, wherein the document comprises a graphical design rendered in a design environment provided by the collaborative workspace.
19. The method of clause 18, wherein the first set of edits and the second set of edits comprise edits to content associated with a visual component of the graphical design.
20. A processing system, comprising: at least one memory having executable instructions thereon; and one or more processors configured to execute the executable instructions to cause the processing system to perform the method of any of clauses 1 through 19.
21. A processing system, comprising: means for performing the method of any of clauses 1 through 19.
22. A non-transitory computer-readable medium having executable instructions stored thereon which, when processed by one or more processors, causes the one or more processors to perform the method of any of clauses 1 through 19.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving, from a user of a first computing system, a first set of edits to a document in a collaborative workspace;
receiving, from a second computing system, a second set of edits to the document in the collaborative workspace, the first set of edits and the second set of edits comprising edits conflicting in time domain;
updating, by the first computing system, the document based a ground-truth representation of the document and on resolving conflicts between the first set of edits and the second set of edits, the ground-truth representation of the document comprising a representation of the document for which conflicts between edits generated on computing systems participating in the collaborative workspace have been resolved; and
displaying the updated document on the first computing system.

2. The method of claim 1, wherein:
the ground-truth representation of the document comprises an ordered list of sequential edits to the document; and
updating the document comprises traversing the ordered list and appending the first set of edits and the second set of edits to the ordered list based on an order in which conflicts are resolved between the first set of edits and the second set of edits.

3. The method of claim 1, wherein the ground-truth representation of the document comprises a snapshot of the document based on which future edits are applied.

4. The method of claim 1, further comprising receiving the ground-truth representation of the document from a server maintaining the collaborative workspace based on connecting the first computing system to the collaborative workspace.

5. The method of claim 1, further comprising transmitting, to a server maintaining the collaborative workspace, the first set of edits.

6. The method of claim 5, wherein the updating the document by the first computing system is performed in parallel with the server updating the document based on the first set of edits and the second set of edits.

7. The method of claim 1, wherein each respective edit in the first set of edits comprises a tuple of a sequence value associated with the respective edit, a location at which the respective edit was performed in the document, and content of the respective edit.

8. The method of claim 1, wherein updating the document comprises resolving conflicts for a subset of a universe of edits made to the document by computing systems participating in the collaborative workspace.

9. The method of claim 1, wherein the document comprises a graphical design rendered in a design environment provided by the collaborative workspace.

10. The method of claim 9, wherein the first set of edits and the second set of edits comprise edits to content associated with a visual component of the graphical design.

11. A processor-implemented method, comprising:
receiving, at a server hosting a collaborative workspace from a first computing system, a first set of edits to a document in the collaborative workspace;
receiving, at the server from a second computing system, a second set of edits to the document in the collaborative workspace, the first set of edits and the second set of edits comprising edits conflicting in time domain;
updating, by the server, the document based on a ground-truth conflict-resolved representation of the document maintained by the server for computing devices participating in the collaborative workspace and resolving conflicts between the first set of edits and the second set of edits; and
distributing the updated document to one or more computing systems, the updated document comprising a base document usable by the one or more computing systems for performing edits locally and propagating the edits to other computing systems participating in the collaborative workspace.

12. The method of claim 11, wherein the updating the document is performed in parallel with local document updates performed by the first computing system and the second computing system.

13. The method of claim 11, wherein the ground-truth conflict-resolved representation of the document comprises an ordered list of sequential edits to the document.

14. The method of claim 11, further comprising generating a snapshot of the updated document, wherein distributing the updated document to the one or more computing systems comprises distributing the generated snapshot.

15. The method of claim 11, wherein updating the document comprises resolving conflicts for a subset of a universe of edits made to the document by computing systems participating in the collaborative workspace.

16. The method of claim 11, further comprising:
determining that the first set of edits to the document are invalid edits to the document; and
discarding the first set of edits such that the document is updated based on the second set of edits but not the first set of edits.

17. The method of claim 16, wherein determining that the first set of edits are invalid edits to the document comprises determining that the first computing system is a malicious computing system.

18. The method of claim 11, wherein the document comprises a graphical design rendered in a design environment provided by the collaborative workspace.

19. The method of claim 18, wherein the first set of edits and the second set of edits comprise edits to content associated with a visual component of the graphical design.

20. A processing system, comprising:
at least one memory having executable instructions stored thereon; and
one or more processors configured to execute the executable instructions to cause the processing system to:
receive, from a user of a first computing system, a first set of edits to a document in a collaborative workspace;
receive, from a second computing system, a second set of edits to the document in the collaborative workspace, the first set of edits and the second set of edits comprising edits conflicting in time domain;
update, by the first computing system, the document based a ground-truth representation of the document and on resolving conflicts between the first set of edits and the second set of edits, the ground-truth representation of the document comprising a representation of the document for which conflicts between edits generated on computing systems participating in the collaborative workspace have been resolved; and
display the updated document on the first computing system.
